(19) United States
(12) Patent Application Publication
(10) Pub. No.: US 2012/0099166 A1
(43) Pub. Date: Apr. 26, 2012

(54) IMAGE READING APPARATUS, IMAGE READING METHOD, AND IMAGE FORMING APPARATUS

(75) Inventors: Hiroyuki Shiraishi, Shizuoka-ken (JP); Mitsuru Hatano, Kanagawa-ken (JP); Sueo Ueno, Shizuoka-ken (JP); Katsuya Nagamochi, Tokyo (JP); Yusuke Hashizume, Chiba-ken (JP); Naoya Koseki, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/277,825

(22) Filed: Oct. 20, 2011

Related U.S. Application Data
(60) Provisional application No. 61/405,468, filed on Oct. 21, 2010.

(51) Int. Cl. H04N 1/04

(52) U.S. Cl. 358/475; 358/474

(57) ABSTRACT

According to one embodiment, an image reading apparatus includes an original document table on which an original document is placed, a detection light source configured to be disposed above the original document table, an irradiation optical system configured to irradiate the original document table with light from the detection light source from a lower surface side of the original document table, and a light guiding optical system configured to guide light reflected from the original document table toward a light detector.

### CROSS-REFERENCE TO RELATED APPLICATION

This application is based upon and claims the benefit of U.S. Provisional Application No. 61/405,468, filed on Oct. 21, 2010; the entire contents of which are incorporated herein by reference.

### FIELD

Embodiments described herein relate generally to an image reading apparatus, an image reading method, and an image forming apparatus.

### BACKGROUND

An MFP (Multi Function Peripheral), which is a type of image forming apparatuses, is a digital multi function apparatus which overall utilizes various office apparatus functions such as a function of receiving an image by FAX, a function of receiving an image by E-mail, a function of receiving a print image through a network as well as a function of scanning, reading, and copying an image.

The image forming apparatus is provided with a plurality of reflection-type sensors using an LED as a sensor detecting the size of an original document to be read. When light emitted from the sensor reaches an original document, the reflected light is detected by a light-receiving unit of the sensor. Accordingly, it is possible to detect whether an original document is present by determining whether the level of the reflected light exceeds a predetermined threshold value.

In this method, however, detection precision may deteriorate when the characteristics of the reflection-type sensor are changed over time. In particular, when an original document is thin or translucent, the detection precision may deteriorate in that the strength of the reflected light is low.

### BRIEF DESCRIPTION OF THE DRAWINGS

FIG. 1 is an exemplary perspective view illustrating the general shape of an image forming apparatus.

FIG. 2 is an exemplary block diagram illustrating the configuration of a reading apparatus.

FIG. 3 is an exemplary plan view illustrating an original document placing unit.

FIG. 4 is an exemplary block diagram illustrating the configuration of a copy function of the image forming apparatus.

FIG. 5 is an exemplary block diagram illustrating the configuration of a control system of the image forming apparatus.

FIG. 6 is an exemplary flowchart illustrating an operation order of a scanning unit.

FIG. 7 is an exemplary diagram for explaining the necessity of calibration.

FIG. 8 is an exemplary diagram for explaining the necessity of the calibration.

FIG. 9 is an exemplary diagram illustrating a calibration method.

FIG. 10A is an exemplary diagram illustrating the calibration method performed using a white reference.

FIG. 10B is an exemplary diagram illustrating the calibration method performed using a white reference.

FIG. 11 is an exemplary diagram illustrating the calibration method performed using a black reference.

FIG. 12 is an exemplary diagram illustrating a method of detecting the size of an original document.

### DETAILED DESCRIPTION

In general, according to one embodiment, an image reading apparatus includes an original document table on which an original document is placed; a detection light source configured to be disposed above the original document table; an irradiation optical system configured to irradiate the original document table with light from the detection light source from a lower surface side of the original document table; and a light guiding optical system configured to guide light reflected from the original document table toward a light detector.

### First Embodiment

Hereinafter, an MFP 201 serving as an image forming apparatus will be described as an example according to an exemplary embodiment.

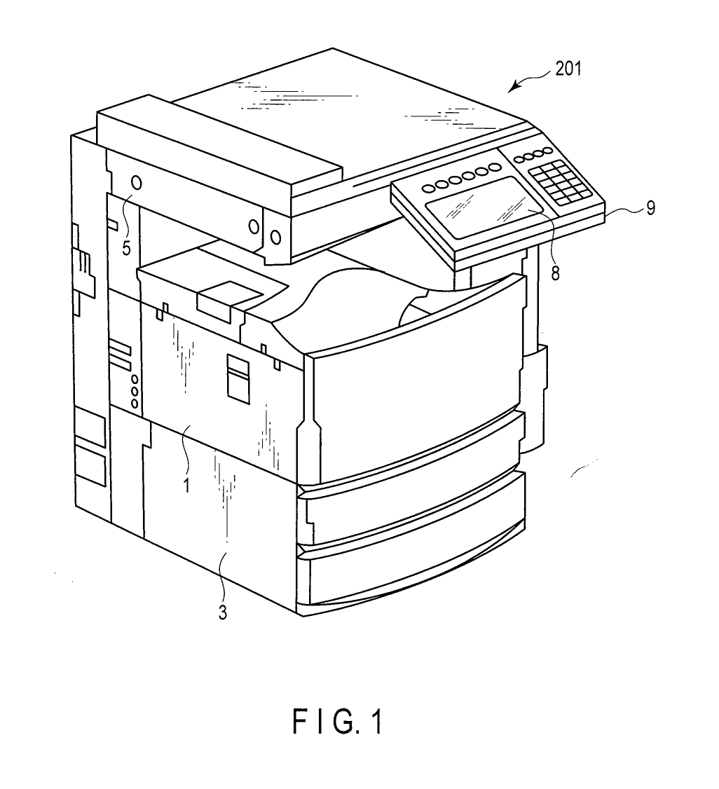

FIG. 1 is an exemplary perspective view illustrating the general shape of the image forming apparatus according to the exemplary embodiment.

The MFP 201 includes a printing unit 1, a paper tray 3, a scanning unit 5, an original document placing unit 7, and an operation panel 9.

The printing unit 1 outputs image information as an output image called, for example, a hard copy or a printout. The paper tray 3 supplies an output medium which is a paper of an optional size used for outputting an image to the printing unit 1. The scanning unit 5 acquires the image information as image data from an original document. The original document placing unit 7 places the original document to be read by the scanning unit 5.

The operation panel 9 is an instruction input unit which gives an instruction to operate the MFP 201, for example, to start forming an image in the printing unit 1 or to start reading the image information regarding the original document in the scanning unit 5. The operation panel 9 includes an LCD 8 used to input an instruction and display information regarding an operator.

Further, the MFP 201 is connected to a network or a communication line (not shown) to receive image data through FAX or E-mail.

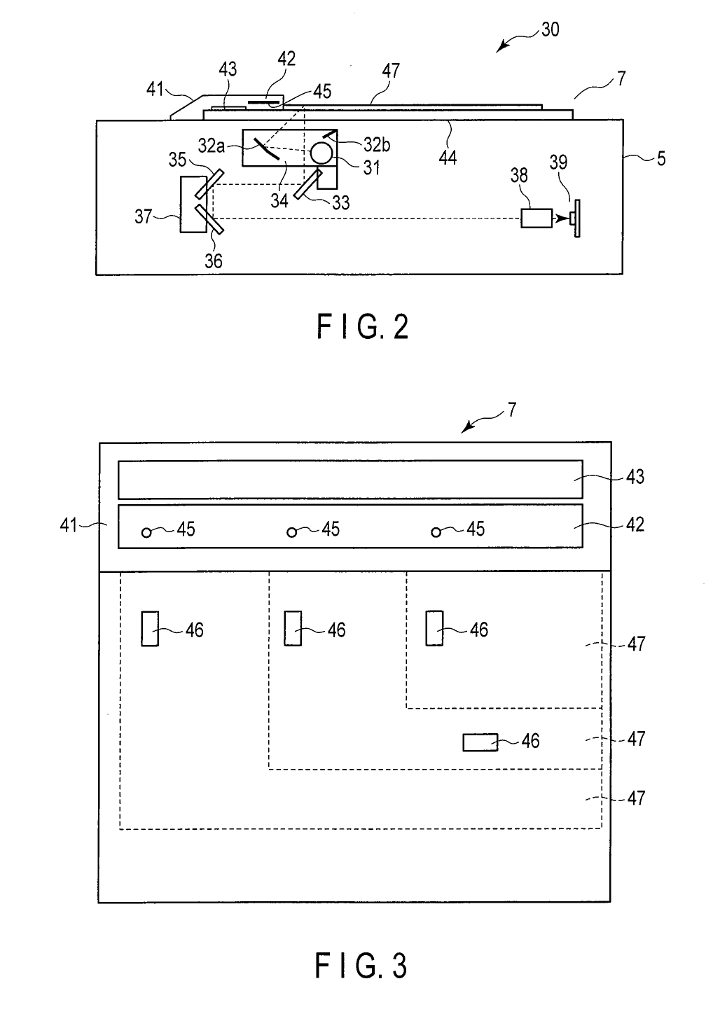

FIG. 2 is an exemplary block diagram illustrating the configuration of a reading apparatus according to the exemplary embodiment.

A reading apparatus 30 includes the scanning unit 5 and the original document placing unit 7. The scanning unit 5 includes a first carriage 34, a second carriage 37, a condensing lens 38, and a CCD sensor 39. The original document placing unit 7 disposed on the upper surface of the scanning unit 5 includes an original document scale 41, an LED substrate 42, a shading plate 43, and an original document table glass 44.

The first carriage 34 includes an exposure lamp 31 serving as a light source, a first reflector 32a and a second reflector 32b reflecting light, and a first mirror 33. The second carriage 37 includes a second mirror 35 and a third mirror 36. The condensing lens 38 condenses incident light and forms the image of a subject in the CCD sensor 39. The CCD sensor 39 converts the image of the subject into an electric image signal.

The original document is placed on the original document table glass 44. The original document scale 41 positions the original document and includes an indicator used to set the original document at a predetermined position. The LED substrate 42 includes LEDs 45 serving as the light source detecting the size of the original document. The shading plate 43 is a color reference member which performs shading correction. In the exemplary embodiment, the shading plate 43 is used for the calibration of the LEDs 45, as described below.

An exposure unit is configured by the first carriage 34 of the scanning unit 5. The first carriage 34 reciprocates along the lower surface of the original document placing unit 7. The lower surface of the original document placing unit 7 is exposed and scanned by lighting up the exposure lamp 31 while reciprocating the first carriage 34.

The image of the reflected light from the original document placed on the original document placing unit 7 can be obtained through the exposure and scanning. The image of the reflected image is reflected from the first mirror 33, the second mirror 35, and the third mirror 36, passes through the condensing lens 38, and is formed on the light-reception surface of the CCD sensor 39.

FIG. 3 is an exemplary plan view illustrating the original document placing unit according to the exemplary embodiment.

The shading plate 43 and the LED substrate 42 are disposed on the internal surface of the original document scale 41. The LED substrate 42 is provided with a plurality of LEDs 45 disposed so as to emit light from the upper side toward the scanning unit 5. The LEDs 45 are disposed among the LED substrate 42 in a main scanning direction (a horizontal direction in the drawing) so as to detect the size of an original document 47. The details of a method of detecting the size of the original document by the LEDs 45 will be described below.

The LEDs 45 may not be disposed on the internal surface of the original document scale 41, but may be disposed on the upper surface of the original document scale 41 so as to emit light through an open hole.

FIG. 3 also shows the positions of reflection-type sensors 46 according to the related art which detect the size of the original document in a sub-scanning direction (a vertical direction in the drawing). The reflection-type sensors 46, which are disposed inside the scanning unit 5, emit light from the lower side toward the original document and receive the reflected light.

In the exemplary embodiment, the size of the original document is detected using both the LEDs 45 and the reflection-type sensors 46. However, the size of the original document may be detected only by the LEDs 45. The size of the original document can be detected only by the LEDs 45 by regulating the kind of the original document 47 and a method of placing the original document 47. The number of LEDs 45 and reflection-type sensors 46 and the positions of the LEDs 45 and the reflection-type sensors 46 are not limited to the description with reference to FIG. 3, but may be determined in accordance with the kind of original document 47 and the method of placing the original document 47.

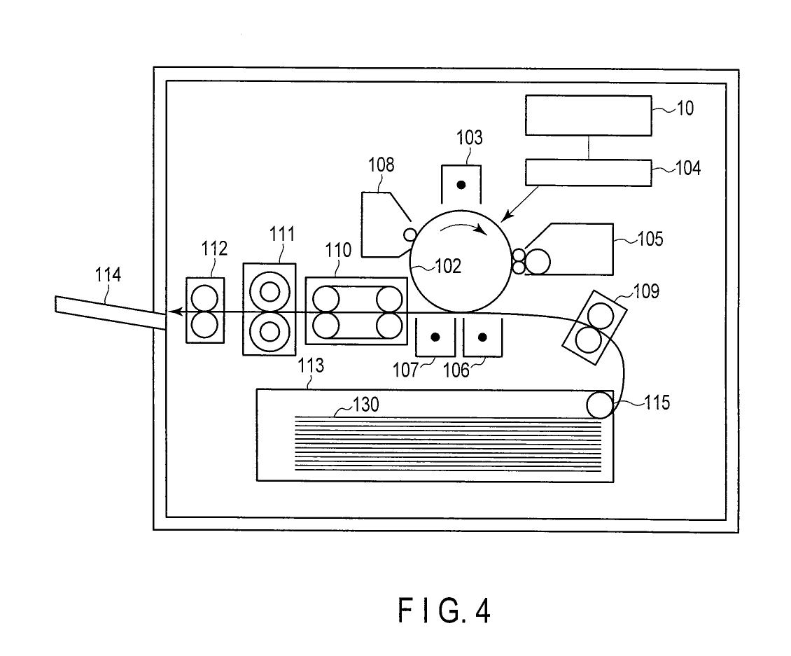

FIG. 4 is an exemplary block diagram illustrating the configuration of a copy function of the image forming apparatus according to the exemplary embodiment.

The MFP 201 includes a control unit 10, a photoconductive drum 102, a charging unit 103, a scanning exposure unit 104, a developing unit 105, a transfer charger 106, a separation charger 107, a cleaner 108, a paper carrying unit 109, a paper transport unit 110, a fixing unit 111, a paper discharge unit 112, and a paper discharge tray 114.

The photoconductive drum 102 rotates in the sub-scanning direction which is a circumferential direction of the photoconductive drum 102. The charging unit 103 is disposed in the vicinity of the circumference of the photoconductive drum 102. The charging unit 103 evenly charges the surface of the photoconductive drum 102. The scanning exposure unit 104 turns on and off in accordance with the image signal while scanning a semiconductor laser in the scanning exposure unit 104. A laser beam emitted from the semiconductor laser is turned to a beam scanned in the main scanning direction which is the direction of the rotation axis of the photoconductive drum 102 by a reflector such as a polygon mirror. An optical system such as a lens irradiates the photoconductive drum 102 with the laser beam. When the charged photoconductive drum 102 is irradiated with the laser beam, the potential near the irradiated portion is lowered and thus an electrostatic latent image is formed.

The developing unit 105 forms a toner image on the photoconductive drum 102 by applying a developer to the photoconductive drum 102. The paper tray 3 is disposed in the lower portion of the MFP 201. A paper carrying roller 115 separates paper sheets 130 in the paper tray 3 one by one and sends the paper sheets 130 to the paper carrying unit 109. The paper carrying unit 109 supplies the paper sheets 130 up to a transfer position of the photoconductive drum 102. The transfer charger 106 transfers the toner image on the supplied paper sheets 130. The separation charger 107 separates the paper sheets 130 from the photoconductive drum 102.

The paper sheets 130 on which the toner image is transferred is transported by the paper transport unit 110. The fixing unit 111 fixes the toner image to the paper sheets 130. The paper discharge unit 112 discharges the paper sheets 130 on which an image is printed to the paper discharge tray 114.

After the toner image is transferred to the paper sheets 130, the toner remaining on the photoconductive drum 102 is removed by the cleaner 108. The photoconductive drum 102 is returned to the initial state and enters a standby state to form a subsequent image.

An image formation process is continuously performed by repeating the above-described process.

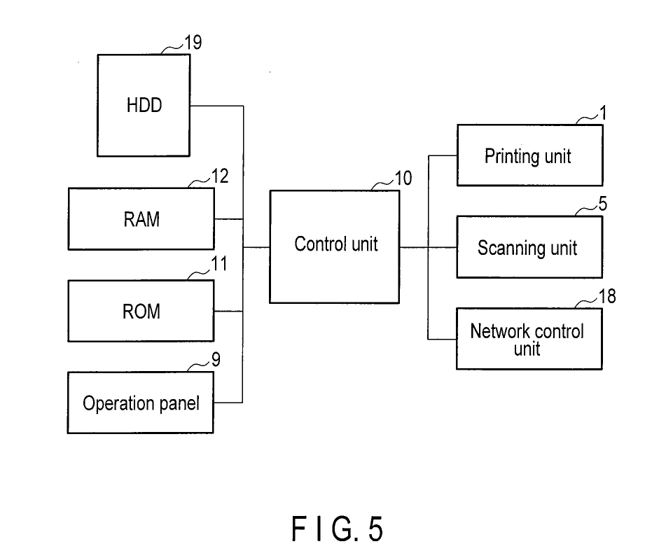

FIG. 5 is an exemplary block diagram illustrating the configuration of a control system of the image forming apparatus according to the exemplary embodiment.

The MFP 201 further includes the control unit 10, a ROM 11, a RAM 12, a network control unit 18, and an internal storage unit (HDD) 19 in addition to the printing unit 1, the paper tray 3, the scanning unit 5, the LCD 8, and the operation panel 9 described above. These units are connected to each other via a system bus.

The control unit 10 controls the above-described hardware units connected to each other via the system bus. The ROM 11 stores various control programs necessary for the MFP 201 to operate. The RAM 12 is a buffer memory which temporarily stores data generated when the control programs are executed.

The network control unit 18 is an interface which transmits and receives information via a network such as the Internet. The HDD 19 is a non-volatile storage medium installed inside the MFP 201.

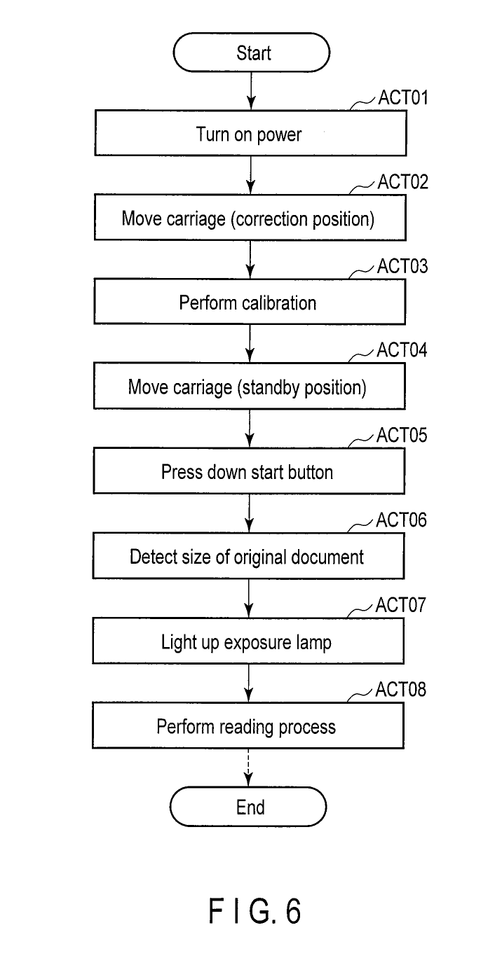

FIG. 6 is an exemplary flowchart illustrating an operation order of the scanning unit 5 according to the exemplary embodiment.

If the power of the MFP 201 is turned on in ACT 01, the first carriage 34 of the scanning unit 5 is moved up to a predetermined correction position in ACT 02. In ACT 03, the scanning unit 5 performs calibration.

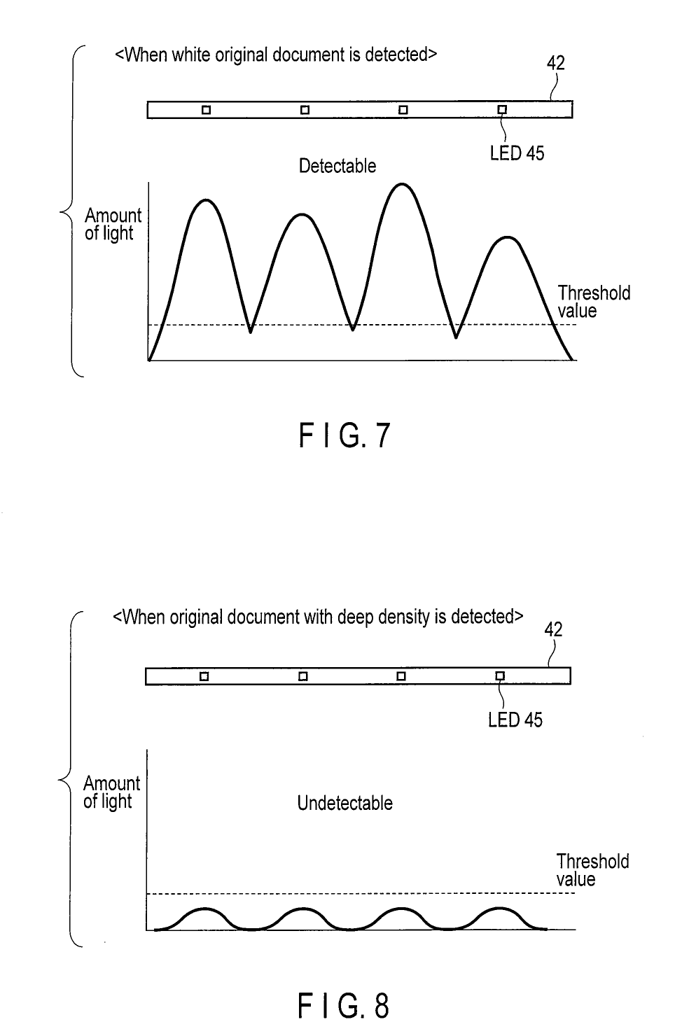

FIGS. 7 and 8 are exemplary diagrams for explaining the necessity of the calibration according the exemplary embodiment.

The LEDs 45 are different from each other in the amount of light, orientation angle, and the like. Therefore, when the LEDs 45 detect a white original document with high luminance, the outputs are not the same, as shown in FIG. 7. Accordingly, when the original document is read, the output is equal to or less than a threshold value for detecting whether the original document is present depending on the LEDs 45, and thus the original document may not be appropriately detected in some cases. As shown in FIG. 8, when the original document with low luminance or deep density is read, the output is equal to or less than the threshold value for detecting whether the original document is present, and thus the original document may not be detected in some cases. This phenomenon occurs due to a variation in the characteristics of the LEDs 45 or a temporal variation. Thus, the LEDs 45 have to be maintained so that the predetermined characteristics can be normally obtained.

In the exemplary embodiment, in ACT 03, control is performed to maintain the predetermined characteristics of the LEDs 45 through the calibration.

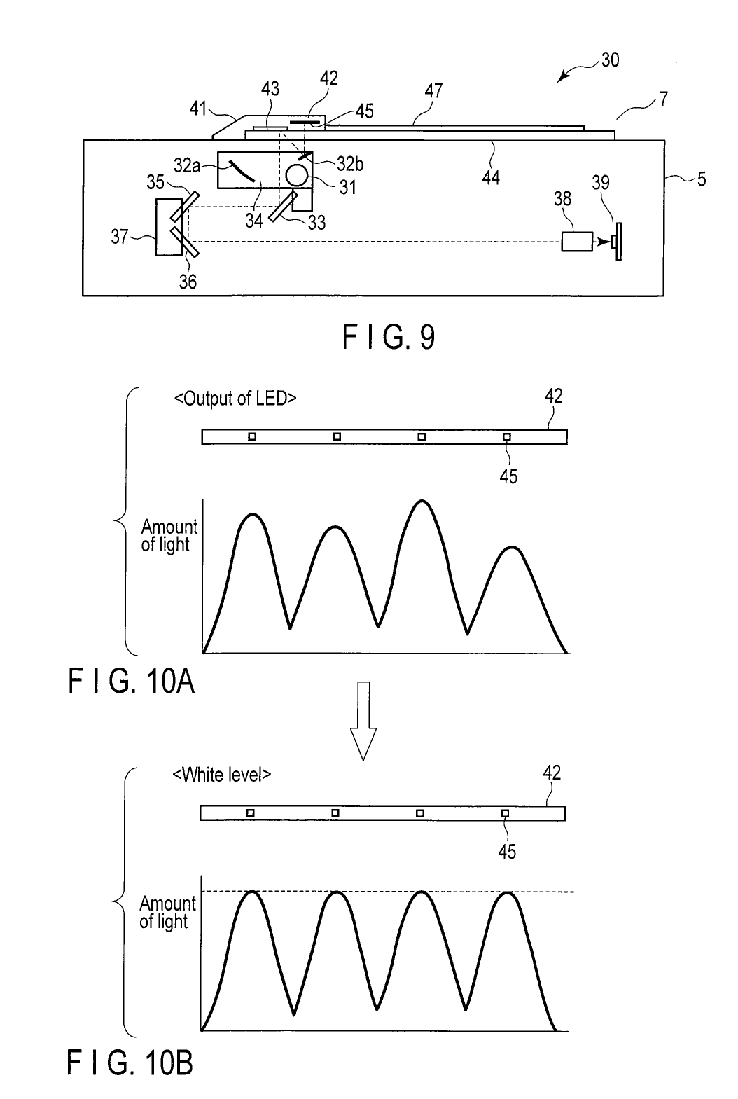

FIG. 9 is an exemplary diagram for explaining a calibration method according to the exemplary embodiment.

First, a white level is adjusted. Therefore, the scanning unit 5 measures the output level of the CCD sensor 39 using the shading plate 43 as a white reference when reading the shading plate 43. In FIG. 9, the first carriage 34 is stopped at the correction position. In this state, the scanning unit 5 lights up all of the LEDs 45 disposed on the LED substrate 42. The light emitted from the LEDs 45 is reflected from the second reflector 32b formed in the first carriage 34 and is emitted to the shading plate 43. The light reflected from the shading plate 43 is imaged on the light-reception surface of the CCD sensor 39 via the first to third mirrors.

FIGS. 10A and 10B are exemplary diagrams illustrating the calibration method performed using the white reference according to the exemplary embodiment.

FIG. 10A shows the output amounts of light of the LEDs 45 detected by the CCD sensor 39. The output levels of the LEDs 45 are irregular. The scanning unit 5 sets the output level of each LED 45 so as to be the maximum gray scale value (white level) based on the output level of the LED 45. FIG. 10B shows the set output levels of the LEDs 45.

The setting is realized, for example, by changing the gain of an AFE (Analog Front End Processor) formed in the CCD sensor 39. Alternatively, the scanning unit 5 may output a signal used to adjust the amount of light output from each LED 45 to the LED 45.

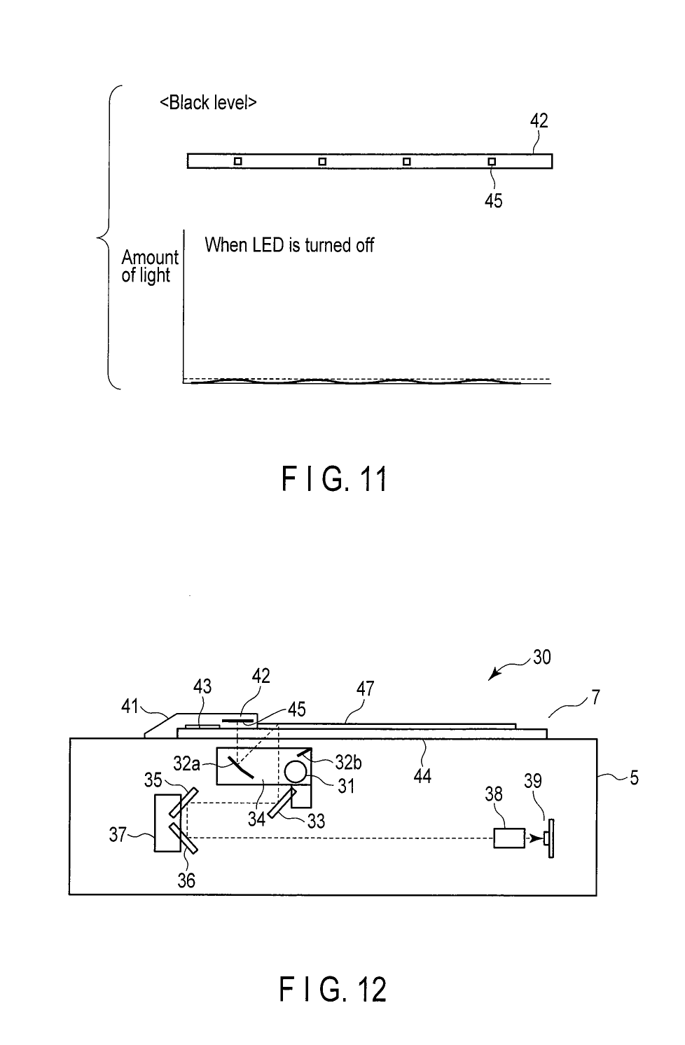

Subsequently, a black level is adjusted. FIG. 11 is an exemplary diagram illustrating the calibration method performed using a black reference according to the exemplary embodiment.

The scanning unit 5 performs level detection when the LEDs 45 and the exposure lamp 31 are turned off. Since the first carriage 34 is located below the original document scale at the correction position, stray light (ambient light) does not enter. Accordingly, the black level can be realized effectively. The scanning unit 5 sets the output level of each LED 45 so as to be the minimum gray scale value (black level) based on the output level of the LED 45. FIG. 11 shows the output levels of the LEDs 45 after setting.

In ACT 04 of FIG. 6, the first carriage 34 of the scanning unit 5 is moved up to a predetermined standby position. If a start button is pressed down to start the process in ACT 05, the scanning unit 5 performs a process of detecting the size of the original document using the LEDs 45 in ACT 06.

FIG. 12 is an exemplary diagram illustrating the method of detecting the size of the original document according to the exemplary embodiment.

In FIG. 12, the first carriage 34 is stopped at the standby position. In this state, the scanning unit 5 lights up all of the LEDs 45 formed on the LED substrate 42. The light emitted from the LEDs 45 is reflected from the first reflector 32a formed in the first carriage 34 and is emitted to the original document 47 via the original document table glass 44. The light reflected from the original document 47 is imaged on the light-reception surface of the CCD sensor 39 via the first to third mirrors. If the original document 47 is not present, the detection signal in the CCD sensor 39 has a low value in that there is no light reflected from the original document. Accordingly, by examining the output level of the CCD sensor 39 corresponding to each LED 45, it is possible to determine whether the original document 47 is present in the sub-scanning direction of each LED 45 with reference to the FIG. 3. Accordingly, the size of the original document can be detected.

In ACT 07 of FIG. 6, the scanning unit 5 lights up the exposure lamp 31. In ACT 08, the scanning unit 5 performs the process of reading the original document. The process of reading the original document in the scanning unit 5 and the process of forming the image will not be described in detail.

In the exemplary embodiment, the light is reflected from the newly provided second reflector 32b when the calibration is performed (FIG. 9). The light is reflected from the first reflector 32a when the image is read (FIG. 2) and the size of the original document is detected (FIG. 12). However, the exemplary embodiment is not limited thereto. Instead, different reflectors may be used when the image is read (FIG. 2) and when the size of the original document is detected (FIG. 12).

The correction position to which the first carriage 34 is moved when the calibration is performed (FIG. 9) is a special position different from the standby position of the first carriage 34 according to the related art before the image forming apparatus starts.

The respective functions described in the above-described exemplary embodiment may be realized by hardware or may be realized by software by causing a computer to read a program in which the respective functions are described. The respective functions may be configured by appropriately selecting any one of the hardware and the software.

Further, the respective functions may be realized by causing a computer to read a program stored in a recording medium (not shown). Any recording format can be used as long as the recording medium according to the exemplary embodiment can store a program and can be read by a computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image reading apparatus comprising:
an original document table on which an original document is placed;
a detection light source configured to be disposed above the original document table;
an irradiation optical system configured to irradiate the original document table with light from the detection light source from a lower surface side of the original document table; and
a light guiding optical system configured to guide light reflected from the original document table toward a light detector.

2. The apparatus according to claim 1,
wherein the irradiation optical system includes a carriage moving along the original document table under the original document table, and
wherein a first reflector mounted on the carriage reflects the light from the detection light source toward the original document table at a first stationary position of the carriage.

3. The apparatus according to claim 2, further comprising:
an original document scale configured to be disposed at an end portion of the original document table and set a placement position of the original document as an indicator,
wherein the detection light source is disposed inside the original document scale.

4. The apparatus according to claim 2, further comprising:
an original document scale configured to be disposed at an end portion of the original document table and sets a placement position of the original document as an indicator; and
a shading plate configured to be disposed under the original document scale,
wherein a second reflector mounted on the carriage reflects the light from the detection light source toward the shading plate at a second stationary position of the carriage, and
wherein the light guiding optical system guides light reflected from the shading plate toward the light detector.

5. The apparatus according to claim 4, further comprising:
a control unit configured to perform control in a manner that the light detector detecting the light reflected from the shading plate output a signal with a predetermined white level.

6. The apparatus according to claim 5, wherein the control unit adjusts an output gain of the light detector and performs control in a manner that the light detector outputs the signal with the predetermined white level.

7. The apparatus according to claim 5, wherein the control unit adjusts the amount of light of the detection light source and performs control in a manner that the light detector outputs the signal with the predetermined white level.

8. The apparatus according to claim 5, wherein the control unit turns off the detection light source at the second stationary position of the carriage and performs control in a manner that the light detector outputs a value of a predetermined black level.

9. The apparatus according to claim 8, wherein the second stationary position of the carriage is located under the original document scale.

10. An image reading method comprising:
forming a detection light source above an original document table on which an original document is placed;
irradiating the original document table with light from the detection light source from a lower surface side of the original document table by an irradiation optical system; and
guiding light reflected from the original document table toward a light detector by a light guiding optical system.

11. The method according to claim 10,
wherein the irradiation optical system includes a carriage moving along the original document table under the original document table, and
wherein a first reflector mounted on the carriage reflects the light from the detection light source toward the original document table at a first stationary position of the carriage.

12. The method according to claim 11, further comprising:
disposing an original document scale at an end portion of the original document table in which the placement position of the original document is set as an indicator,
wherein the detection light source is disposed in the original document scale.

13. The method according to claim 11, further comprising:
disposing an original document scale, in which a placement position of the original document is set as an indicator, at an end of the original document table; and
disposing a shading plate under the original document scale,
wherein a second reflector mounted on the carriage reflects the light from the detection light source toward the shading plate at a second stationary position of the carriage, and
wherein the light guiding optical system guides light reflected from the shading plate toward the light detector.

14. The method according to claim 13, further comprising:
controlling, by a control unit, in a manner that the light detector detecting the light reflected from the shading plate outputs a signal with a predetermined white level.

15. The method according to claim 14, further comprising:
adjusting an output gain of the light detector and performing control, by the control unit, in a manner that the light detector outputs the signal with the predetermined white level.

16. The method according to claim 14, further comprising:
adjusting the amount of light of the detection light source and performing control, by the control unit, in a manner that the light detector outputs the signal with the predetermined white level.

17. The method according to claim 14, further comprising:
turning off the detection light source at the second stationary position of the carriage and performing control, by the control unit, in a manner that the light detector outputs a value of a predetermined black level.

18. The method according to claim 17, wherein the second stationary position of the carriage is located under the original document scale.

19. An image forming apparatus comprising:
an original document table on which an original document is placed;
a detection light source configured to be disposed above the original document table;
an irradiation optical system configured to irradiate the original document table with light from the detection light source from a lower surface side of the original document table;
a first light guiding optical system configured to guide light reflected from the original document table toward a light detector;
an exposure lamp configured to expose the original document table;
a carriage configured to move the exposure lamp along the original document table;
a second light guiding optical system configured to guide the light reflected from the original document table to the light detector with the exposure and movement of the exposure lamp; and
an image forming unit configured to form an image corresponding to an image signal output from the light detector on an image-formed medium.
